(19) United States
(12) Patent Application Publication
(10) Pub. No.: US 2010/0187900 A1
(43) Pub. Date: Jul. 29, 2010

(54) HYDRAULIC POWER BRAKE SYSTEM

(75) Inventors: Andreas Remmelmann, Karlstein Am Main (DE); Hubertus Mies, Lohr AM Main (DE); Arne Weidemann, Aschaffenburg (DE); Dietmar Seubert, Steinfeld (DE)

Correspondence Address: MICHAEL J. STRIKER, 103 EAST NECK ROAD, HUNTINGTON, NY, 11743, US

(73) Assignee: ROBERT BOSCH GHBH, STUTTGART (DE)

(21) Appl. No.: 12/678,212

(22) PCT Filed: Sep. 30, 2008
(86) PCT No.: PCT/DE08/01621

§ 371 Date: Mar. 15, 2010

(51) Int. Cl. B60T 8/36; B60T 13/74

(52) U.S. Cl. 303/3

(57) ABSTRACT

The invention relates to a hydraulic power brake system comprising a manually operated brake valve (4) via which a pressure medium connection between a brake line (BR1, BR2) and a storage circuit (S1, S2) or a reservoir (T; 70) can be controlled to open. A pilot-controlled, continuously adjustable directional valve (16-22) is provided in the pressure medium flow path between a wheel brake cylinder (26-32) and the brake valve (4), said directional valve being controllable via two pilot valves (86, 90).

The present invention relates to a hydraulic power brake system according to the preamble of claim 1.

Heavy vehicles that are used in construction, agriculture, and forestry, and special vehicles must include brake systems that have a high level of operational reliability despite low operating forces, especially for use on difficult terrain. In vehicles of this type, power brake systems are used in which the braking force is not applied directly by the driver, but rather directly via a hydraulic accumulator or the like. Hydraulic power brake systems and pneumatic power brake systems are basically known, although hydraulic systems are often preferred since it is very easy to supply energy via hydraulic systems that are already present on the vehicle, and since hydraulic components, in particular the wheel brake cylinder, require less space than pneumatic components, they allow highly precise applications to be carried out due to the low hysteresis involved, and they ensure short response times even at low temperatures.

Hydraulic power brake systems of this type are described in data sheet RD 66 226/06.00 from Mannesmann Rexroth AG. According to that data sheet, in a 2-circuit power brake system, a pressure medium connection between the wheel brake cylinders of the particular brake circuit and one hydraulic accumulator in each case is controlled open via a power brake system valve that is actuated using a brake pedal. The hydraulic accumulator is charged via an accumulator charge valve by a pump that supplies the brake system with pressure medium with priority over the other loads as soon as the accumulator pressure reaches a lower limit value. When the power brake system is actuated, the pressure in the wheel brake cylinders is regulated in proportion to the actuating force of the pedal. In the case of fast-moving vehicles in particular, the aim is to provide the power brake systems with antilock brake system functionality (ABS functionality). Since the wheel brake cylinders of hydraulic power brake systems of this type have a very large intake volume, ABS systems from the automotive industry may not be used since their valves are designed for the smaller intake volumes of automotive brakes. Although ABS solutions for pneumatic power brake systems are known, they require a great deal of installation space due to the low energy density of compressed air, and they have the disadvantages described above. Hydraulic solutions are therefore preferred.

In post-published DE 10 2006 024 183, a valve system is described, in which the fast-switching ABS valves are used to precontrol one 2/2 directional control valve each. By combining two 2/2 directional control valves of this type with two fast-switching ABS pilot valves, it is possible to design a quasi continuously adjustable 3/2 directional control valve, using which it is possible to control the pressure medium volumetric flows required for ABS functionality, in order to actuate a wheel brake cylinder. The disadvantage of this solution is that it is highly complex in terms of the device itself and the control engineering since two of the aforementioned 2/2 directional control valves, including a total of four ABS pilot valves, must be assigned to every wheel brake cylinder.

In contrast, the object of the present invention is to create a hydraulic power brake system that includes ABS functionality and has a simple design.

According to the present invention, the hydraulic power brake system includes a manually actuated brake valve, via which it is possible to control open a pressure medium connection between a brake line, which has a pressure medium connection to a wheel brake cylinder, and a hydraulic accumulator or a tank. According to the present invention, a pilot-controlled, continuously adjustable directional control valve is located in the pressure medium flow path between the wheel brake cylinder and the brake valve, and includes a brake port, a tank port, and a pressure port that is connected to an output port of the brake valve. This directional control valve is preloaded via a spring into a home position, and is acted upon, in one direction, by a control pressure that acts on one control surface, and, in the other direction, is acted upon by a pressure in the brake line that acts on another control surface. The control pressure may be changed by controlling open pilot valve elements using an ABS control unit. That is, according to this solution, the brake pressure is controlled during ABS regulation via a 3-way directional control valve that is controlled open via two simply designed pilot valve elements, thereby resulting in a design of the power brake system that is more compact and cost favorable than the post-published solution described initially.

In a preferred embodiment of the present invention, a control chamber of the directional control valve may be acted upon with pressure via a first pilot valve, and may be connected to the tank via a second pilot valve.

According to the present invention, it is preferrable for the latter pilot valve to be a fast-switching 2/2 directional control valve. It is preferably designed to be normally closed.

In an embodiment having a particularly simple design, the first pilot valve may be designed as a nozzle. As an alternative, a fast-switching 2/2 directional control valve of the type used in automotive applications may also be used.

This pilot valve is preferably designed to be normally open.

The continuously adjustable directional control valve may be normally open or normally closed relative to the pressure port.

A pressure compensation valve may be installed in every circuit to compensate for any pressure differences that may exist at the wheel brake cylinders of an axle. A throttle may be assigned to this pressure compensation valve in each brake line.

The design of the power brake system having ABS functionality is particularly simple when a conventional ABS control unit for small volumetric flows is used for activation. This ABS control unit may be adapted, by making relatively few changes, to the requirements of power brake systems that are typically operated, e.g., using hydraulic oil instead of the usual brake fluid.

The continuously adjustable 3-way directional control valve includes a valve spool that is preloaded into its home position via the aforementioned spring, and which includes a control groove, each of the annular end faces of which forms a control edge. Via these control edges, the opening cross-section between the pressure port and the brake port is determined, as is the opening cross-section between the brake port and the tank port. The pressure at the brake port acts via a signalling channel on a spool control surface, while the aforementioned control pressure acts on the other spool control surface.

According to a solution that is very compact and has a simple design, the signalling channel extends through the spool.

The spring is located in a rearward control chamber, in which the control pressure also acts.

According to a preferred design of this directional control valve, the control edges of the valve spool are designed such that, in an intermediate region between the working positions of the directional control valve, the opening cross-sections between pressure port and brake port and tank port and brake port are blocked, thereby ensuring that the switchover may take place in a more steady manner.

It is particularly advantageous when the brake valve according to claims 15 and 16 may also be automatically actuated independently of a manual actuation of the brake pedal. It is then possible to build up brake pressure in critical driving states, independently of the driver's intervention, e.g., for electronic stability control for protection against skidding, or for traction control.

Other advantageous developments of the present invention are the subject matter of further dependent claims.

Preferred embodiments are explained below in greater detail with reference to the schematic drawings.

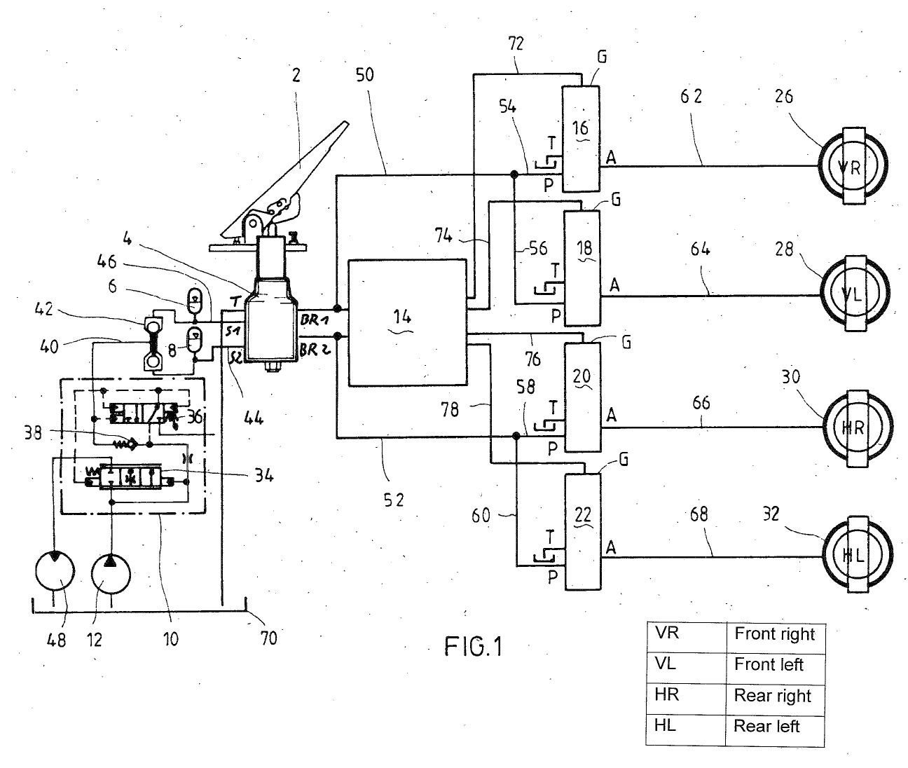

FIG. 1 shows a schematic diagram of a hydraulic 2-circuit power brake system;

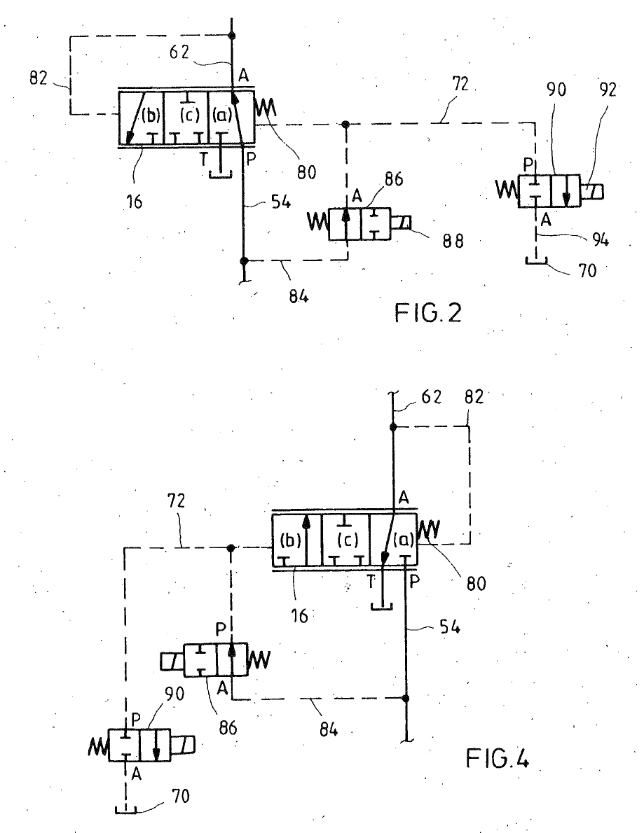

FIG. 2 shows a hydraulic circuit symbol of a pilot-controlled directional control valve of the power brake system depicted in FIG. 1;

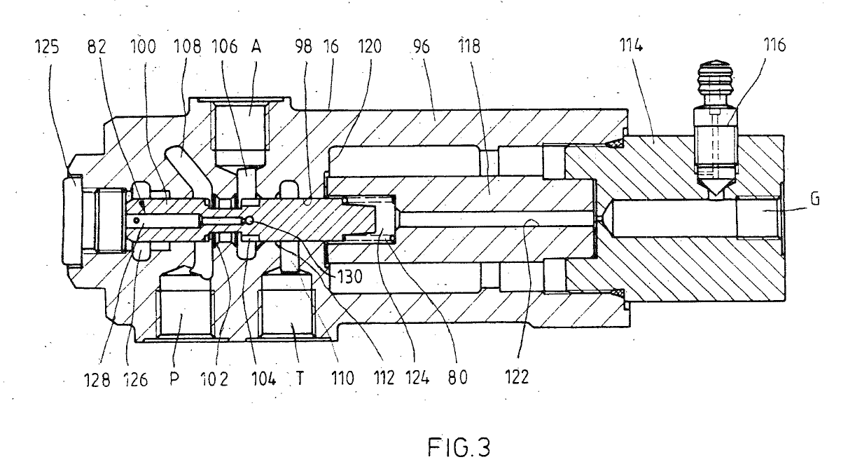

FIG. 3 shows a cross section through a specific solution of the directional control valve depicted in FIG. 2;

FIG. 4 shows a circuit symbol of a variant of the pilot-controlled directional control valve as depicted in FIG. 2,

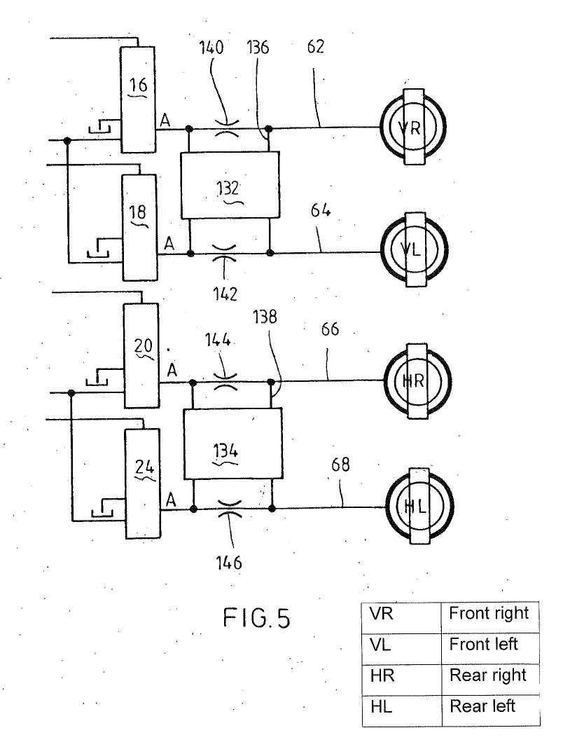

FIG. 5 shows a portion of a power brake system that includes a directional control valve of that type, and

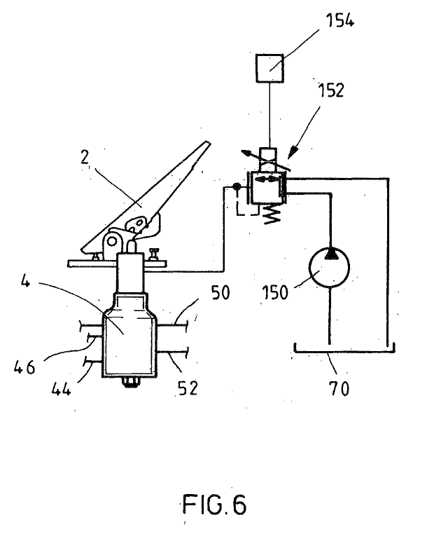

FIG. 6 shows a variant of the 2-circuit power brake system depicted in FIG. 1, which includes additional functionalities.

FIG. 1 shows a schematic diagram of a hydraulic power brake system 1, e.g., for a fast-moving tractor, a dump truck, or a communal vehicle. Power brake system 1 is mainly composed of a power brake valve that is actuated using a brake pedal 2, and that is referred to below as brake valve 4, two hydraulic accumulators 6, 8, an accumulator charge valve 10, a pump 12, an ABS control unit 14, and four relay valves 16, 18, 20, 22, via which it is possible to apply brake pressure to one wheel brake cylinder 26, 28, 30, 32 each. Wheel brake cylinders 26, 28 are assigned to the front axle, and the two other wheel brake cylinders 30, 32 are assigned to the rear axle.

The basic design of brake valve 4, which is actuated via brake pedal 2, and accumulator charge valve 10, and the connection to hydraulic accumulators 6, 8 are extensively described in aforementioned data sheet RD 66 226/06.00, and therefore only the elements that are essential to the understanding of the present invention will be described here; as for the rest, reference is made to the disclosure in this data sheet.

Accumulator charge valve 10 is designed to hold a pressure level in the accumulator circuit within certain limit values, and it includes a pressure scale 34, an adjustable pressure-adjusting element 36, and a non-return valve 38. During the charging procedure of hydraulic accumulators 6, 8, pump 12 pumps pressure medium into an accumulator supply line 40 which is connected to the inlet of inverse directional control valve 42. Its two outputs are connected via accumulator lines 44, 46 to accumulator ports S1 and S2 of brake valve 4. Hydraulic accumulators 6, 8 are connected to supply lines 44 and 46, respectively. Pressure scale 34 throttles the pump delivery flow until the pressure in the accumulator circuit overcomes the spring force of pressure-adjusting element 36. When this default pressure is reached, a pressure medium connection to a load port is controlled open via the pressure scale, thereby making it possible to supply a secondary load, which is indicated in FIG. 1 using reference numeral 48, with pressure medium. In terms of the description of the exact functionality of the accumulator charge valve, reference is made to the aformentioned data sheet, or to data sheet RD 66 191/08.04 from Bosch Rexroth AG.

Brake valve 4 is a standard valve, e.g., of the type described in aforementioned data sheet RD 66 226/06.00, or in data sheet RD 66 146/10.03 from Bosch Rexroth AG. A power brake valve of this type includes aforementioned accumulator ports S1, S2, a tank port T, and brake ports BR1 and BR2 which are assigned to each brake circuit.

When brake pedal 2 is actuated, then, via brake valve 4, a pressure medium connection between accumulator ports S1, S2 and assigned output port BR1, BR2 is controlled open, thereby enabling brake pressure to build up in brake pressure lines 50, 52 which are connected to output ports BR1, BR2. Brake pressure lines 50, 52 each branch off into two supply lines 54, 56 and 58, 60, each of which is connected to a pressure port P of particular relay valve 16, 18, 20, 22, the design of which is described in greater detail below. Each relay valve 16, 18, 20, 22 includes a brake port A which is connected via one brake line 62, 64, 66 or 68 to one assigned wheel brake cylinder 26, 28, 30, 32. Each relay valve 16, 18, 20, 22 also includes a tank port, which is connected to tank 70, and a control port G, which is connected via one control line 72, 74, 76, 78 to ABS control unit 14.

ABS control unit 14 is a modified product from the automotive field. In that field, the brake systems are operated using brake fluid, while utility vehicles typically use the same pressure medium as do working hydraulics. It must be noted that the elastomers that are typically used to seal conventional ABS control devices are not suitable for use with hydraulic oil.

The basic design of an ABS control unit 14 of this type has been known for some time from the technical literature. Reference is made, for instance, to the technical book “Fachkunde Kraftfahrzeugtechnik” (Automotive Technology); Europa Lehrmittel; 25^{th} edition 1994; page 460ff. ABS control units 14 of this type typically include an electronic control unit, via which fast-switching ABS valves assigned to each wheel are activated. In these known solutions, a return pump is provided, via which brake fluid is pumped into a line section between a main brake cylinder and the ABS valves during ABS regulation in automotive applications. In one modification of ABS control unit 14, this return pump is eliminated, and the seals are optimized for use with hydraulic oil. Furthermore, ABS control unit 14 does not include separate, integrated pressure medium accumulators. As shown in the illustration in FIG. 1, the inlets of ABS control unit 14 are connected to brake pressure lines 50, 52. In the solution that is shown, an ABS control unit 14 is used, in which two fast-switching 2/2 directional ABS valves are assigned to each wheel brake cylinder 26, 28, 30, 32; in contrast to automotive applications, the 2/2 directional ABS valves do not directly determine the pressure in brake lines 62, 64, 66, 68, but rather act as pilot-control valves for aforementioned relay valves 16, 18, 20, 22.

FIG. 2 shows a circuit symbol of a pilot-controlled relay valve 16, 18, 20, 22 of this type; the particular ABS valves, which are referred to below as pilot valves, are integrated in ABS control unit 14.

The basic design of relay valve 16 is explained as an example with reference to FIG. 2. The design of the other relay valves is similar. Relay valve 16 is based on a known design, which is described in data sheet RD 66 226/06.00, or in data sheet RD 66 152/10.03 from Bosch Rexroth AG. Relay valve 16 is a proportionally adjustable pressure reduction valve having a 3-direction design, and which includes aforementioned ports P, T and A. Pressure port P is connected to line 54, and output or brake port A is connected to brake line 62. A valve spool of relay valve 16 is preloaded via a spring 80 into a home position a, in which pressure port P is connected to output port A—relay valve 16 is therefore designed, in the embodiment shown in FIG. 1, as a normally open valve; in the home position, the pressure in brake pressure lines 50, 52 is switched through to the wheel brake cylinders. If brake pedal 2 is not actuated, however, brake pressure lines 50, 52 are connected to tank 70 via brake valve 4. The pressure in brake line 62 or at brake port A is tapped via a signalling channel 82 and acts on a control surface of the valve spool in opposition to the force of spring 80. Furthermore, a control channel 84 branches off of brake pressure line 50 or supply line 54 and leads to inlet connection P of a pilot valve 86. This is designed to be normally open, and may be moved into a blocking position by supplying current to a solenoid 88; in the blocking position, the pressure medium connection between control channel 84 and a control line 72 that is connected to output port A of the pilot valve is blocked. A pressure in control 72 acts as control pressure on the valve spool of relay valve 16 in the direction of action of spring 80.

Furthermore, a pilot valve 90 is connected to control line 72, is normally closed, and, by supplying current to a solenoid 92, may be brought into an opened position in which an inlet port P, which is connected to control line 72, is connected to a tank control line 94 that is connected to an output port A; tank control line 94 empties into tank 70. In the home position of relay valve 16 that is shown, with pilot valve 86 open and tank control line 94 blocked, the two control surfaces of relay valve 16 are acted upon by the same pressure, and so, assuming that the two control surfaces are the same size, the valve spool of relay valve 16 is pressure-compensated. It is then preloaded via the force of spring 80 into its home position a. When valves 86, 90 are switched over, the pressure medium connection between control line 72 and control channel 84 is blocked, and a pressure medium connection to tank 70 is controlled open, thereby relieving the control pressure in control line 72 toward the tank; accordingly, the valve spool of relay valve 16 is displaced via the pressure in signalling channel 82 in the direction of its position labelled b; in an intermediate position c, the pressure medium connections between ports A, P, T are initially blocked via the control edges. In the positions labelled b, output port A is connected to tank port T, thereby making it possible for the brake pressure to build in brake line 62 which is connected thereto. Via fast-switching valves 86, 90, which are designed to be sufficiently large for the low control oil volumetric flows that occur, relay valve 16, which is designed to accommodate a large volumetric flow of pressure medium, may therefore be switched over to build brake pressure or to decrease brake pressure; the desired brake pressure is regulated by activating valves 86, 90 in a suitable manner. For example, the two pilot valves are activated briefly and in alternation, and a control pressure that is normalized for the pressure in control channel 84 and that results from the ratio of activation times is introduced into control line 72.

Instead of actuating valves 86, 90 via solenoids 88, 92, it is also possible to use other suitable actuators, e.g., piezoelectric actuators.

In an embodiment of the present invention having a particularly simple design, connecting pilot element 86 may also be formed by a nozzle which, in order to lower the brake pressure, may be used to reduce the pressure in control line 72 by opening pilot valve 98 in a pulsed manner, or to relieve the brake pressure entirely by opening pilot valve 98 for a sustained period of time.

The specific design of relay valve 16, which is normally open, will now be explained with reference to FIG. 3.

Relay valve 16 includes a valve housing 96 in which ports P, T, and A, and control port G are formed. A valve spool 100 extends in a valve bore 98 of valve housing 96, and includes a control groove which is located approximately in the center, on the annular end faces of which control grooves 102, 104 are formed; control grooves 102, 104 determine the opening cross-sections between ports P, A and A, T in the control region before a fluid path is opened in the valve.

Output port A empties into an output channel 106, input port P empties into a pressure channel 108, and tank port T empties into a tank port 110; chamfers 112 are formed in the transition region to valve bore 98, only one of which is labeled with a reference numeral in FIG. 3. In the depiction shown in FIG. 3, valve bore 98 expands toward the right, and a connection piece 114, which forms control port G, is screwed into the expanded end section. A bleed screw 116 is also installed in connection piece 114, using which it is possible to bleed the control oil flow path. Via connecting piece 114, a bushing 118 is pressed against an annular end face 120; bushing 118 extends, via sections, into connecting piece 114, and is therefore guided in the axial direction and the radial direction. Bushing 118 is penetrated by an axial bore 122 which empties into valve bore 98 and expands toward valve spool 98, which extends via its end section depicted on the right in FIG. 3 into a spring chamber 124 which is formed by the expansion and in which spring 80 is supported. It acts on the adjacent end section of valve spool 100, thereby preloading it, in its home position, against a screw plug 125 that closes housing 96 on its end face.

In the region of screw plug 125, valve bore 98 expands toward a control chamber 126 into which the—left as shown in FIG. 3—section of valve spool 100 extends. The pressure that is present at output port A acts on control chamber 126 via signalling channel 82. In the embodiment shown, signalling channel 82 is formed by a signalling bore 128 that extends in the axial direction, and that leads via one or more radial bores into outer surface of valve spool 100, thereby making it possible to tap the pressure at output port A via signalling channel 82. This pressure therefore acts on the left—as shown in FIG. 3—end face of valve spool 100 which has the same diameter as the right end section of the valve spool, which extends into spring chamber 124. Control port G is connected to aforementioned control line 72. Accordingly, in the home position of pilot valves 86, 90, which is shown in FIG. 2, valve spool 100 is pressure-compensated, and is therefore preloaded toward the left, into the stop position, against screw plug 125 by the force of spring 80. In this home position (a), which is shown in FIG. 2, the pressure medium connection between ports P, A is open, and the pressure medium connection between ports A, T is blocked.

By switching pilot valves 86, 90, the pressure in spring chamber 124 is reduced partially or entirely, and so valve spool 100 is displaced, by a brake pressure in brake line 62 that is present in signalling channel 82 and, therefore, in control chamber 126, to the right (FIG. 2) until it reaches an equilibrium position. The pressure medium connection from port P to A is controlled closed, and the pressure medium connection from port A to T is opened, in order to reduce the brake pressure. In order to maintain pressure, the valve spool is located in the central position which has positive overlap. The design according to the present invention makes it possible to also provide conventional power brake systems of heavy utility vehicles with ABS functionality in a relatively simple manner; the fast-switching ABS valves, which are known from the automotive field, make it possible to rapidly adjust relay valves 16, 18, 20, 22, via which the large braking volumetric flows are controlled. Due to the extensive use of known components, this power brake system may be realized in a very simple manner.

In the solution described above, relay valves 16, 18, 20, 22 are normally open. In the embodiment described with reference to FIGS. 4 and 5, the relay valve is normally closed relative to pressure port P. The circuit symbol of a relay valve 16 of this type is shown in FIG. 4. The valve is designed such that, in the spring-preloaded home position (a), brake or output port A is connected to tank port T. Relay valve 16 is adjusted in a mirror-image manner compared to the above-described embodiment, i.e., the pressure in signalling channel 82 acts in the same direction as spring 80, i.e., in the direction of home position (a). The pressure in control line 72 acts in the opposite direction. In the home position of pilot valves 86 and pilot valve 90, the valve spool may be moved, via the pressure in supply line 54 and against the force of spring 80, into position (b) in which the pressure medium connection to tank T is blocked in order to build up brake pressure, and the pressure medium connection between pressure port P and output port A is controlled open. When valves 86, 90 are switched over, control line 72 is relieved toward tank 70, while the brake pressure in brake line 62 is also present in signalling channel 82—the valve spool of relay valve 16 is then quickly displaced past intermediate position (c) in the direction of positions (a).

In this variant, it is possible, in particular when braking is initiated, for slightly different pressures to form in brake lines 62, 64 and 66, 68 of each brake circuit during “normal” braking without ABS. In order to prevent pressure differentials of this type from forming in brake lines 62, 64 and 66, 68, a compensation valve 132, 134 is installed between each of the particular brake lines, as shown in FIG. 4, via which it is possible to compensate for unequal brake pressures in brake lines 62, 64; 66, 68. Compensation valve 132, 134 is active only during normal braking, however; pressure is not compensated for during ABS regulation. By activating a compensation valve 132, 134 of this type, the pressure in brake lines 62, 64; 66, 68 is detected, and compensation valve 132,134 is activated as a function of this pressure. If a tolerable pressure difference is exceeded, compensation valve 132, 134 opens a connecting line 136, 138 between brake lines 62, 64; 66, 68 in order to compensate for the pressure. Throttles 140, 142; 144, 146 may be installed in the pressure build-up direction, upstream of connecting lines 136, 138. The pressure drop may be detected via throttles 140, 142; 144, 146 and utilized in order to activate compensation valves 132, 134. Compensation valves of this type are known from the automotive industry, e.g., from WO 2004/016487 A1.

Compared to the system shown in FIG. 1, the variant of a power brake system as shown in FIG. 6 also includes an auxiliary pump 150 which is driven by a not-shown electric motor, an electromagnetically proportionally adjustable pressure control valve 152, and an electronic control unit 154 which may be used to activate the solenoid of the pressure control valve. The pressure control valve is connected to the pressure port of auxiliary pump 150 and to tank 70, and via its control port, to a control port of brake valve 4 which is a special design of brake valve 4 shown in FIG. 1. This special design of a brake valve is known per se from DE 103 25 875 A1 or US 2006/0097565 A1, FIGS. 2 and 3. Otherwise, the power brake system shown in FIG. 6 includes the same components and fluid connections as the power brake system shown in FIG. 1.

In the power brake system, brake pressure may be built up without the vehicle driver actuating brake pedal 2. Electronic stability control and traction control may be realized. If the system detects the presence of a critical driving situation, e.g., the possibility that the vehicle will skid or the wheels will slip, pressure control valve 152 is activated by control unit 154 and builds a pilot control pressure at its control output and the associated pilot control port of the brake valve. The brake valve is hydraulically actuated, and brake pressure is available to brake a specific individual wheel with the aid of the relay valve and its pilot valves which are assigned to this wheel. Since the brake pressure that is active at this wheel may be modulated via the pilot valves, it is possible to use, instead of the proportionally adjustable pressure control valve, a pressure control valve that may be switched to a fixed value. It is even possible to use a directional control valve if auxiliary pump 150 is a variable-displacement pump that is adjusted to the certain pressure value, or if the pump pressure of the auxiliary pump, which is designed as a fixed-delivery pump, is limited to the certain pressure via a pressure-limiting valve. This pressure may be, e.g., 30 bar, which results in a brake pressure of 100 bar at outputs BR1 and BR2 of brake valve 4.

Since critical driving states, in which stability control or traction control is required, occur very rarely since nearly all vehicle drivers drive defensively, an electric motor that drives auxiliary pump 150 is advantageously switched on only when a critical driving state is detected by the electronic control device, to avoid wasting energy.

The present invention discloses a hydraulic power brake system that includes a manually actuated brake valve, via which it is possible to control open a pressure medium connection between a brake line and an accumulator circuit or a tank. A pilot-controlled, continuously adjustable directional control valve, which may be activated using two pilot valves, is located in the pressure medium flow path between the wheel brake cylinder.

Reference Numerals:

1 Power brake system

2 Brake pedal

4 Brake valve

6 Hydraulic accumulator

8 Hydraulic accumulator

10 Accumulator charge valve

12 Pump

14 ABS control unit

16 Relay valve

18 Relay valve

20 Relay valve

22 Relay valve

26 Wheel brake cylinder

28 Wheel brake cylinder

30 Wheel brake cylinder

32 Wheel brake cylinder

34 Pressure compensator

36 Pressure-adjusting element

38 Non-return valve

40 Accumulator supply line

42 Inverse directional-control valve

44 Accumulator line

46 Accumulator line

48 Secondary loads

50 Brake pressure line

52 Brake pressure line

54 Supply line

56 Supply line

58 Supply line

60 Supply line

62 Brake line

64 Brake line

66 Brake line

68 Brake line

70 Tank

72 Control line

74 Control line

76 Control line

78 Control line

80 Spring

82 Signalling channel

84 Control channel

86 Pilot valve

88 Solenoid

90 Pilot valve

92 Solenoid

94 Tank control line

96 Valve housing

98 Valve bore

100 Valve spool

102 Control groove

104 Control groove

106 Output channel

108 Pressure channel

110 Tank channel

112 Chamfer

114 Connecting piece

116 Bleed screw

118 Bushing

120 Annular end face

122 Axial bore

124 Spring chamber

125 Screw plug

126 Control chamber

128 Signalling bore

132 Compensating valve

134 Compensating valve

136 Connecting line

138 Connecting line

140 Throttle

142 Throttle

144 Throttle

146 Throttle

150 Auxiliary pump

152 Pressure-relief valve

154 Control unit

What is claimed is:

1. A hydraulic power brake system comprising a manually actuated brake valve (4) via which it is possible to control open a pressure medium connection between at least one brake line (62, 64, 66, 68), which has a pressure medium connection to a wheel brake cylinder (26, 28, 30, 32), and a hydraulic accumulator (6, 8) or a tank (70), wherein
a pilot-controlled, continuously adjustable directional control valve (16, 18, 20, 22) is located in the pressure medium flow path between the wheel brake cylinder (26, 28, 30, 32) and the brake valve (4), and includes a brake port that is connected to the brake line (62, 64, 66, 68), a tank port (T), and a pressure port (P) that is connected to an output port (BR1, BR2) of the brake valve (4), and which is preloaded into a home position, and which is acted upon, in one direction, by a control pressure that acts on one control surface, and, in the other direction, is acted upon by a pressure in the brake line (62, 64, 66, 68) that acts on another control surface, it being possible to change the control pressure via pilot valve elements (86, 90) using an antilock braking system control unit (14).

2. The power brake system as recited in claim 1, in which a control chamber (124) of the directional control valve (16, 18, 20, 22) may be acted upon with pressure via a first pilot valve (86), and may be connected to the tank (70) via a second pilot valve (90).

3. The power brake system as recited in claim 2, in which a pilot valve (90) is a fast-switching 2/2 directional control valve.

4. The power brake system as recited in claim 3, in which the second pilot valve (90) is normally closed.

5. The power brake system as recited in claim 2, in which the first pilot valve (86) is a valve or a fast-switching 2/2 directional control valve.

6. The power brake system as recited in claim 2, in which the first pilot valve (86) is a fast-switching, electrically actuated 2/2 directional control valve that is normally open.

7. The power brake system as recited in claim 1, in which the directional control valve (16, 18, 20, 22) is normally open or normally closed relative to the pressure port (P).

8. The power brake system as recited in claim 7, comprising a compensation valve (132, 134) for equalizing the brake pressure in the brake lines (62, 64; 66, 68) that are assigned to an axle.

9. The power brake system as recited in claim 8, in which a throttle (140, 142; 144, 146) is installed in each brake line (62, 64; 66, 68).

10. The power brake system as recited in claim 1, in which the antilock brake system control unit (14) is designed for low volumetric flows.

11. The power brake system as recited in claim 1, in which the directional control valve (16, 18, 20, 22) includes a valve spool (100) which is preloaded via a spring (80) into its home position (a), and which includes an annular groove, each of the annular end faces of which forms a control edge (102, 104), one of which determines the opening cross-section between the pressure port and the brake port (A), and the other of which determines the opening cross-section between the brake port (A) and the tank port (T); via a signalling channel (82), the pressure at the brake port (A) is directed to a control chamber (126) that is limited by a spool control surface, and the control pressure acts on the other control surface of the valve spool (100).

12. The power brake system as recited in claim 11, in which the signalling channel (82) extends through the valve spool (100).

13. The power brake system as recited in claim 11, in which the spring is located in a rearward spring chamber (125), in which the control pressure acts.

14. The power brake system as recited in claim 11, in which the control edges (102, 104) are designed such that, in an intermediate position (c) of the valve spool (100), the opening cross-sections between the pressure port (P) and the brake port (A) and the tank port (T) and the brake port (A) are blocked.

15. The power brake system as recited in claim 1, in which the brake valve (4) may be actuated automatically, independently of a manual actuation.

16. The power brake system as recited in claim 15, in which a pressure source (150) is used to hydraulically actuate the brake valve (4).
